(19) United States
(12) Patent Application Publication
(10) Pub. No.: US 2026/0235135 A1
(43) Pub. Date: Aug. 13, 2026

(54) BLOWER

(71) Applicant: Panasonic Intellectual Property Management Co., Ltd., Osaka (JP)

(72) Inventor: TSUYOSHI KURITA, Fukuoka (JP)

(21) Appl. No.: 19/469,357

(22) PCT Filed: Feb. 7, 2024
(86) PCT No.: PCT/JP2024/004126

§ 371 Date: Sep. 25, 2025

(30) Foreign Application Priority Data
May 31, 2023 (JP) 2023-090057

(51) Int. Cl. F04D 29/056; F04D 29/063; F04D 29/32; H02K 5/167; H02K 21/22

(52) U.S. Cl. CPC F04D 29/056; F04D 29/063; F04D 29/325; H02K 5/1675; H02K 21/22

(57) ABSTRACT

A blower (10) includes: a housing (60) including a recess (63) that is open upward; a sleeve (70) disposed in the recess and including a through-hole (71); a shaft (314) extending through the through-hole; a cap portion (80) disposed above the sleeve with the shaft extending therethrough; a propeller (31) connected to an upper end of the shaft; and a lubricant (90) contained in the recess. The cap portion includes a first cap (81) and a second cap (82) disposed above the first cap. The first cap incudes a first vent (814) and a first pass-through portion (813) through which the shaft extends. The second cap includes a second pass-through portion (823) through which the shaft extends.

### TECHNICAL FIELD

The present disclosure relates to blowers.

### BACKGROUND ART

Conventionally, in blowers mounted in electronic devices, such as laptop computers and on-board electronic devices (such as automotive navigation systems and light-emitting diode (LED) headlamps), the spacing between a shaft and a sleeve that rotatably holds the shaft is filled with a lubricant (for example, refer to Patent Literature (PTL) 1).

### CITATION LIST

### Patent Literature

PTL 1: Unexamined Japanese Patent Publication No. 2020-106045

### SUMMARY OF INVENTION

A blower according to an aspect of the present disclosure includes: a housing including a recess that is open upward; a sleeve disposed in the recess and including a through-hole; a shaft extending through the through-hole; a cap portion disposed above the sleeve with the shaft extending therethrough; a propeller connected to an upper end of the shaft; and a lubricant contained in the recess. The cap portion includes a first cap and a second cap disposed above the first cap. The first cap incudes a first vent and a first pass-through portion through which the shaft extends. The second cap includes a second pass-through portion through which the shaft extends.

With the blower according to an aspect of the present disclosure, the leakage of the lubricant can be reduced.

### BRIEF DESCRIPTION OF DRAWINGS

FIG. 1 is a perspective view illustrating the external appearance of a blower according to an exemplary embodiment.

FIG. 2 is a cross-sectional perspective view of a blower according to an exemplary embodiment.

FIG. 3 is an exploded perspective view of a bearing portion and a shaft according to an exemplary embodiment.

FIG. 4 is a top view of a housing according to an exemplary embodiment.

FIG. 5 is a cross-sectional perspective view of a sleeve according to an exemplary embodiment.

FIG. 6 is a top view of a cap portion according to an exemplary embodiment.

FIG. 7 is a perspective view of a first cap according to an exemplary embodiment viewed from above.

FIG. 8 is a perspective view of a first cap according to an exemplary embodiment viewed from below.

FIG. 9 is a perspective view of a second cap according to an exemplary embodiment viewed from above.

FIG. 10 is a perspective view of a second cap according to an exemplary embodiment viewed from below.

FIG. 11 is a cross-sectional view of a bearing portion according to an exemplary embodiment.

FIG. 12 is an enlarged cross-sectional view of a portion of a blower according to an exemplary embodiment.

FIG. 13 is a partial cross-sectional view of a blower according to an exemplary embodiment, disposed with a posture such that the axis thereof extends horizontally.

FIG. 14 is a top view of a second cap according to Variation 1.

FIG. 15 is a top view of a second cap according to Variation 2.

### DESCRIPTION OF EMBODIMENTS

A blower according to technique 1 includes: a housing including a recess that is open upward; a sleeve disposed in the recess and including a through-hole; a shaft extending through the through-hole; a cap portion disposed above the sleeve with the shaft extending therethrough; a propeller connected to an upper end of the shaft; and a lubricant contained in the recess. The cap portion includes a first cap and a second cap disposed above the first cap. The first cap incudes a first vent and a first pass-through portion through which the shaft extends. The second cap includes a second pass-through portion through which the shaft extends.

If the lubricant contains air bubbles, the air bubbles may cause the shaft and the sleeve to come into direct contact, potentially leading to seizing. When the first cap includes the first vent as in the present aspect, the air bubbles can be released to the outside through the first vent, enabling a reduction in seizing issues due to the air bubbles. Furthermore, since the cap portion has a double structure of the first cap and the second cap, even if the lubricant leaks through the first pass-through portion and the first vent of the first cap, the second cap can minimize further leakage. In particular, the lubricant that has leaked from the first cap can be returned to the inside of the first cap through the first vent. Thus, the leakage of the lubricant can be reduced.

Technique 2 is the blower described in technique 1 in which the first vent is preferably a cutout on the first pass-through portion.

Since air bubbles within the lubricant tend to gather around the shaft, when the first vent is a cutout on the first pass-through portion, the air bubbles are directed to the first vent, allowing for easy release of the air bubbles. Thus, seizing issues due to the air bubbles can be further reduced.

Technique 3 is the blower described in technique 1 or technique 2 in which the second cap preferably further includes a second vent.

Thus, the second cap includes the second vent, allowing the air bubbles released through the first vent to be released to the outside through the second vent. This facilitates the smooth release of the air bubbles.

Technique 4 is the blower described in technique 3 in which the second vent is preferably a cutout on the second pass-through portion.

Thus, the second vent is a cutout on the second pass-through portion, allowing the air bubbles gathering around the shaft to be efficiently released to the outside through the second vent.

Technique 5 is the blower described in any one of technique 1 to technique 4 in which a first distance between the first cap and the second cap is preferably greater than a second distance between the sleeve and the first cap.

Thus, the first distance is greater than the second distance, which ensures that even if the lubricant leaks out to the area defined by the first distance, the lubricant can be contained therein. This allows for a reduction in the leakage of the lubricant from the second cap. Furthermore, since the second distance is less than the first distance, pressure can be readily generated to circulate the lubricant into the area defined by the second distance. This also allows for the smooth circulation of the lubricant.

Technique 6 is the blower described in any one of technique 1 to technique 5 in which an outer peripheral portion of the first cap preferably includes a first recess in the form of a cutout.

Thus, the outer peripheral portion of the first cap includes the first recess, allowing the air bubbles to be released also through the first recess. Moreover, the lubricant present between the first cap and the second cap can be collected from the first recess into the recess of the housing.

Technique 7 is the blower described in technique 6 in which an outer peripheral portion of the second cap preferably includes a second recess in the form of a cutout that overlaps the first recess as viewed in the up-down direction (as viewed from above).

Thus, the outer peripheral portion of the second cap includes the second recess that overlaps the first recess, allowing the air bubbles released through the first recess to be released to the outside through the second recess.

Technique 8 is the blower described in technique 7 in which the area of the second recess is preferably greater than or equal to the area of the first recess as viewed in the up-down direction (as viewed from above).

Thus, the area of the second recess is greater than or equal to the area of the first recess as viewed in the up-down direction (as viewed from above), which ensures that even if the lubricant leaks out of the second cap, the lubricant can be guided from the second recess to the first recess, and the collection of the lubricant can be facilitated. When the area of the first recess viewed in the up-down direction (viewed from above) is set to induce capillary action, the effect of facilitating the collection improves.

Technique 9 is the blower described in technique 7 in which the depth of the second recess measured from the outer peripheral edge of the second cap is preferably greater than or equal to the depth of the first recess measured from the outer peripheral edge of the first cap as viewed in the up-down direction (as viewed from above).

Thus, the depth of the second recess measured from the outer peripheral edge of the second cap is greater than or equal to the depth of the first recess measured from the outer peripheral edge of the first cap as viewed in the up-down direction (as viewed from above), which ensures that even if the lubricant leaks out of the second cap, the lubricant can be guided from the second recess to the first recess, and the collection of the lubricant can be facilitated. When the depth of the first recess measured from the outer peripheral edge of the first cap is set to induce capillary action, the effect of facilitating the collection improves.

Technique 10 is the blower described in any one of technique 1 to technique 9 in which an outer peripheral portion of the first cap preferably includes a slit extending toward the center of the first cap.

Thus, the outer peripheral portion of the first cap includes the slit, which ensures that the lubricant that has leaked out to the area between the first cap and the second cap can be collected from the slit into the recess of the housing.

### EXEMPLARY EMBODIMENT

Hereinafter, a blower according to an exemplary embodiment (including variations thereof) of the present invention will be described with reference to the drawings. Note that each exemplary embodiment described below shows a general or specific example. The numerical values, shapes, materials, structural elements, the arrangement and connection of the structural elements, etc., shown in the following exemplary embodiment are mere examples, and are not intended to limit the present invention. The respective figures do not necessarily show precise dimensions, etc. The same or similar structural elements are assigned the same reference signs throughout the figures.

In the following description and the drawings, a direction along the axis of a shaft included in the blower is defined as a Z-axis direction, and directions perpendicular to each other in a plane perpendicular to the Z-axis direction are defined as an X-axis direction and a Y-axis direction. Note that depending on the mode of use, it is conceivable that the Z-axis direction may be other than the up-down direction; however, for the sake of explanation, the following description assumes that the Z-axis direction is the up-down direction.

In the following description, an expression indicating a relative direction or a posture such as “parallel” and “perpendicular” encompasses a direction or posture that is not the intended direction or posture in a strict sense. For example, the phrase “two directions are parallel” means that said two directions are perfectly parallel or are substantially parallel, for example, within a few percent deviation from perfect parallelism.

### [Configuration of Blower]

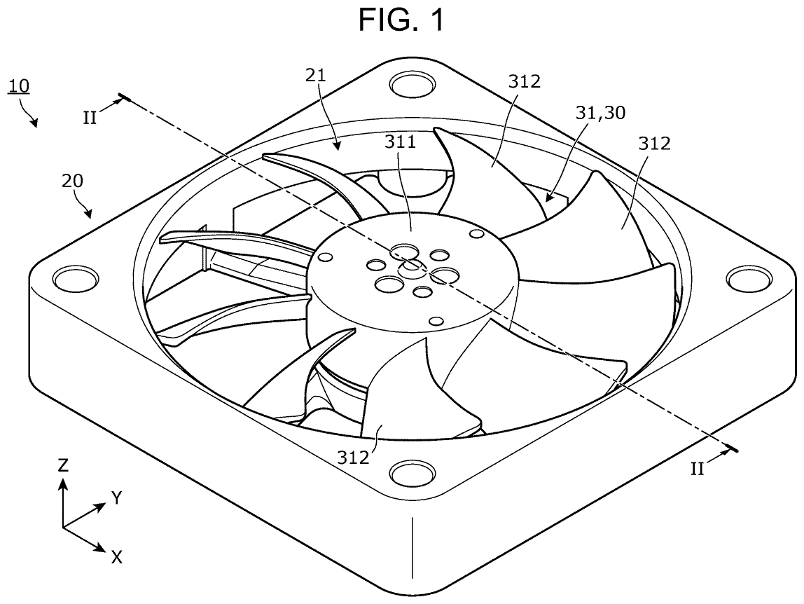

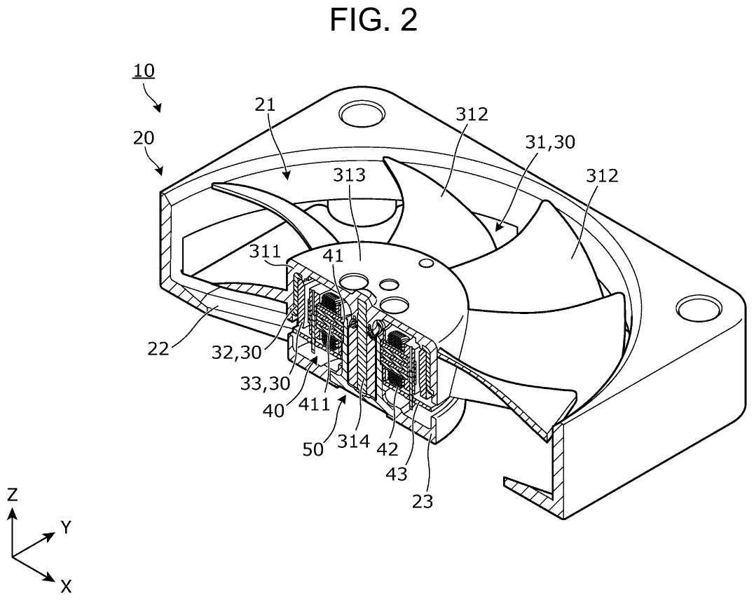

First, the outline of blower 10 according to an exemplary embodiment will be described. FIG. 1 is a perspective view illustrating the external appearance of blower 10 according to the exemplary embodiment. FIG. 2 is a cross-sectional perspective view of blower 10 according to the exemplary embodiment. Specifically, FIG. 2 is a cross-sectional perspective view illustrating a cut surface including line II-II in FIG. 1.

As illustrated in FIG. 1 and FIG. 2, blower 10 according to the exemplary embodiment includes frame 20, rotor portion 30, stator portion 40, and bearing portion 50.

Frame 20, which is a member that houses rotor portion 30, stator portion 40, and bearing portion 50, includes opening portion 21 in the shape of a column that is open in the up-down direction. At a lower end portion in opening portion 21, a plurality of beam portions 22 (in FIG. 2, only one beam portion 22 is illustrated) extending from the inner edge to the center of opening portion 21 are arranged radially. Base 23 that holds rotor portion 30, stator portion 40, and bearing portion 50 is coupled to leading ends of the plurality of beam portions 22. In other words, base 23 is disposed in a center area of opening portion 21.

Rotor portion 30 includes propeller 31, yoke 32, and magnet 33. Propeller 31 includes: body portion 311 in the shape of a cylinder with a closed bottom; and a plurality of blades 312 extending outward from the periphery of body portion 311.

Body portion 311 is formed in the shape of a cylinder that includes bottom portion 313 in an upper area and is open in a lower area. Yoke 32 in the shape of a cylinder is attached to the inner peripheral surface of body portion 311, and magnet 33 in the shape of a cylinder is attached to the inner peripheral surface of yoke 32. Shaft 314 in the shape of a column having an axis extending in the Z-axis direction is fixed in an area of bottom portion 313 that is located at the center in plan view (as viewed in the Z-axis direction).

Stator portion 40 is a portion that generates magnetic flux according to a drive current. Stator portion 40 includes: stator core 41; a plurality of coils 42 attached to stator core 41; and circuit board 43 for supplying electric power to each coil 42. Stator core 41 is, for example, a laminated steel plate formed by axially stacking magnetic steel sheets such as silicon steel sheets. Stator core 41 is directly or indirectly fixed to base 23. Stator core 41 includes a plurality of teeth 411 that project outward, and coils 42 are attached to respective teeth 411. As a result, the plurality of coils 42 are arranged at equal intervals along a circumference centered on stator core 41. The plurality of coils 42, which are a collection of wound conducting wires, are electrically connected to circuit board 43 disposed directly below coils 42. Each coil 42 is disposed inward of yoke 32 and magnet 33.

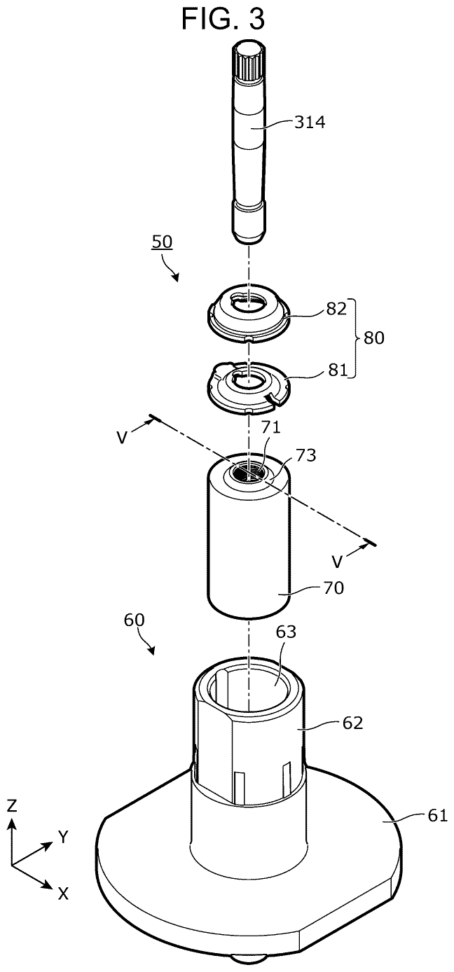

Next, bearing portion 50 will be described in detail. Bearing portion 50 is a portion that rotatably supports shaft 314 of propeller 31. FIG. 3 is an exploded perspective view of bearing portion 50 and shaft 314 according to the exemplary embodiment. As illustrated in FIG. 3, bearing portion 50 includes housing 60, sleeve 70, and cap portion 80.

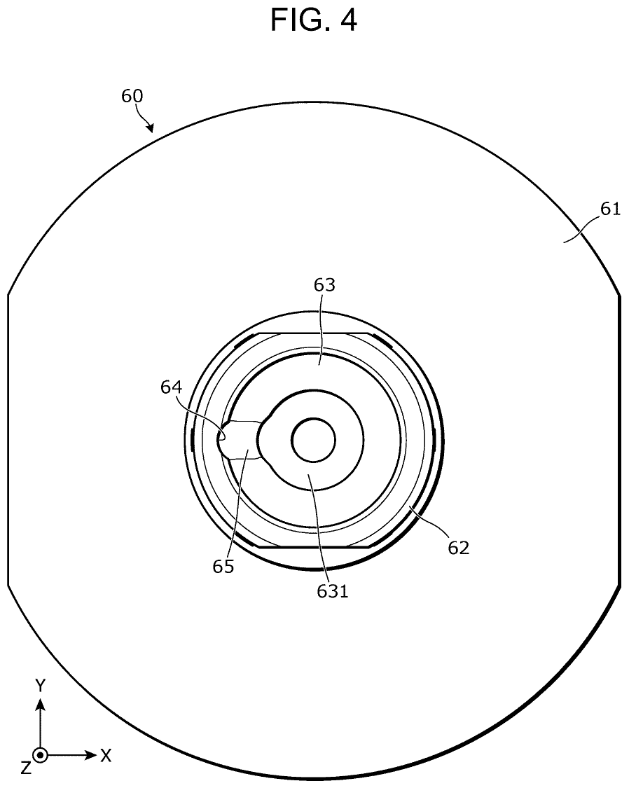

Housing 60 is a member that houses a portion of shaft 314, sleeve 70, and cap portion 80. FIG. 4 is a top view of housing 60 according to the exemplary embodiment. As illustrated in FIG. 3 and FIG. 4, housing 60 includes: base portion 61 in the form of an oval plate in plan view; and cylindrical portion 62 projecting upward from base portion 61. Cylindrical portion 62 is open in an upper area and has a bottom at a lower end. Therefore, the inside of cylindrical portion 62 is recess 63 in the shape of a column including an opening in the upper area. On the inner peripheral surface of recess 63, first housing groove 64 extending from the upper end portion to the bottom along the Z-axis is formed at an end in the negative X-axis direction.

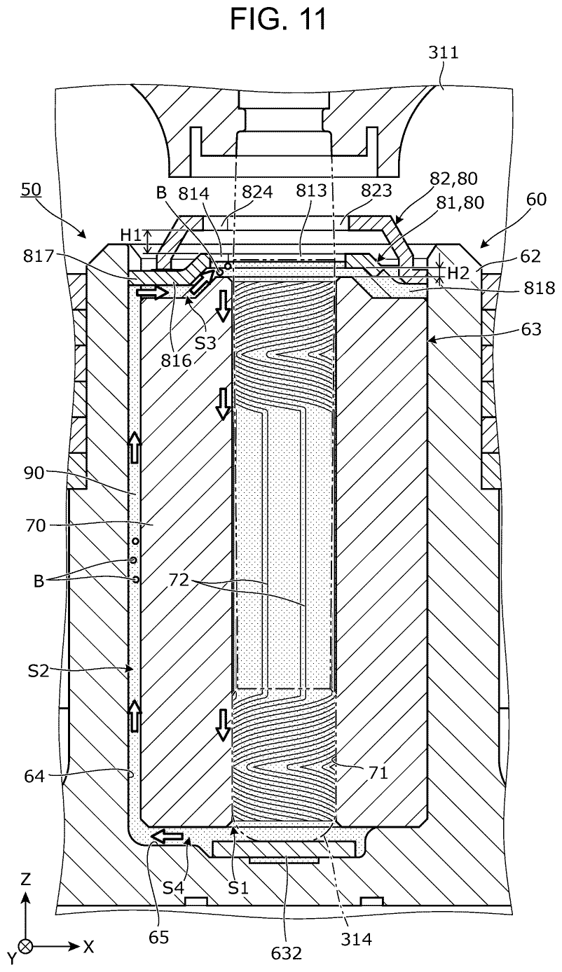

As illustrated in FIG. 4, depression 631 in the shape of a circle is formed in a center area of the bottom surface of recess 63, and receiving plate 632 (refer to FIG. 11) that receives the leading end of shaft 314 is disposed in depression 631. On the bottom surface of recess 63, second housing groove 65 extending along the X-axis is formed in order to connect first housing groove 64 and depression 631.

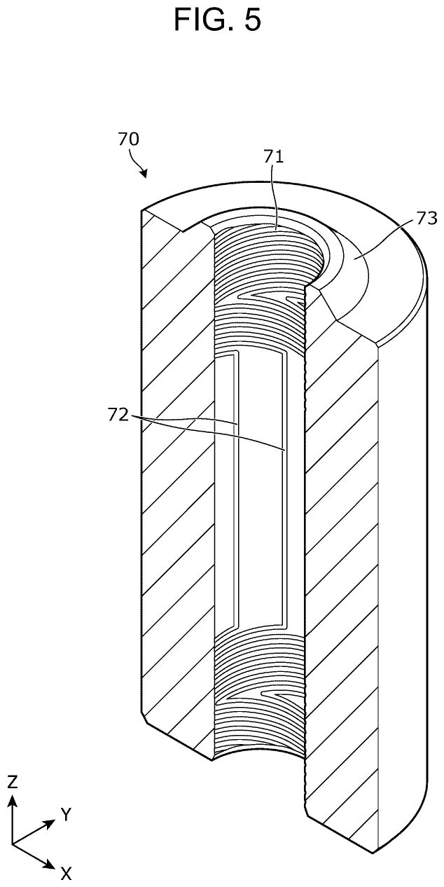

FIG. 5 is a cross-sectional perspective view of sleeve 70 according to the exemplary embodiment. Specifically, FIG. 5 is a cross-sectional perspective view illustrating a cut surface including line V-V in FIG. 3. As illustrated in FIG. 3 and FIG. 5, sleeve 70 is a cylindrical member through which through-hole 71 extending along the Z-axis is formed at the center as viewed in the Z-axis direction. In through-hole 71, shaft 314 is disposed to extend through through-hole 71. A plurality of guide grooves 72 are formed on the inner peripheral surface (inner side surface) of sleeve 70, that is, the inner peripheral surface thereof that forms through-hole 71. The plurality of guide grooves 72 are arranged at predetermined intervals in the circumferential direction. Each guide groove 72 is shaped such that an upper portion and a lower portion thereof are bent and a middle portion therebetween is in a straight line along the Z-axis. For example, in the case where shaft 314 rotates counterclockwise as viewed in the positive Z-axis direction (as viewed from above), the bent shape of the upper portion and the lower portion of each guide groove 72 is tapered in the direction of rotation of shaft 314. The spacing between shaft 314 and sleeve 70 is filled with lubricant 90 (refer to FIG. 11); when shaft 314 rotates, said shape of each guide groove 72 allows lubricant 90 to be propelled downward. Note that the number of guide grooves 72 to be provided or the shape of each guide groove 72 are not limited as long as this allows lubricant 90 to be generally propelled downward even if lubricant 90 is partially propelled upward.

The outer peripheral surface (outer side surface) of sleeve 70, which has no constrictions, is a cylindrical surface. Projecting portion 73 that projects upward is formed on the upper surface of sleeve 70 around through-hole 71. The outer peripheral surface of projecting portion 73 is tapered upward. An area of the upper surface of sleeve 70 other than projecting portion 73 and the leading end surface (upper surface) of projecting portion 73 are flat surfaces.

At the time of manufacture, when sleeve 70 is housed in recess 63 of housing 60, a plurality of caulked portions (not illustrated in the drawings) are formed in edge areas of the upper surface of sleeve 70. With these caulked portions, a portion of the outer peripheral surface of sleeve 70 expands outward and is joined to the inner peripheral surface of housing 60 or fits into first housing groove 64 to the extent that said first housing groove 64 is not closed, for example. Thus, sleeve 70 is fixed in recess 63 of housing 60.

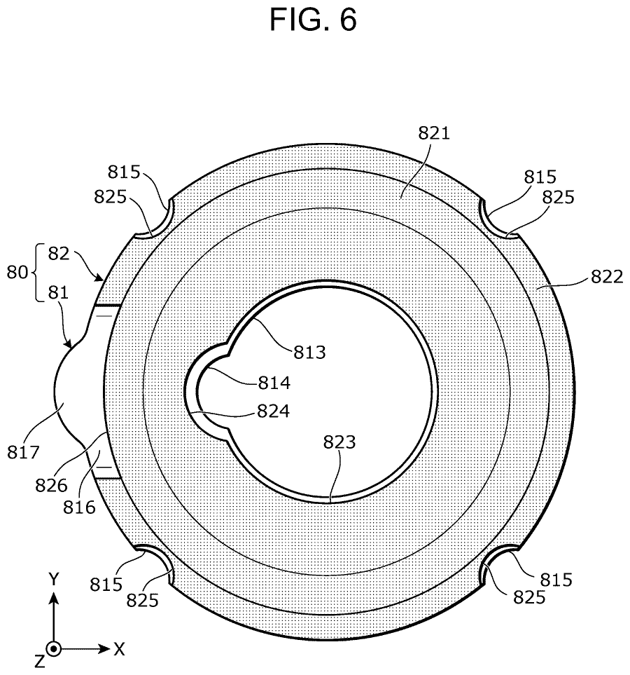

FIG. 6 is a top view of cap portion 80 according to the exemplary embodiment. In FIG. 6, second cap 82 included in cap portion 80 is shown with dot shading. As illustrated in FIG. 3 and FIG. 6, cap portion 80 includes: first cap 81; and second cap 82 disposed above first cap 81. First cap 81 and second cap 82 are disposed above sleeve 70 with shaft 314 extending therethrough.

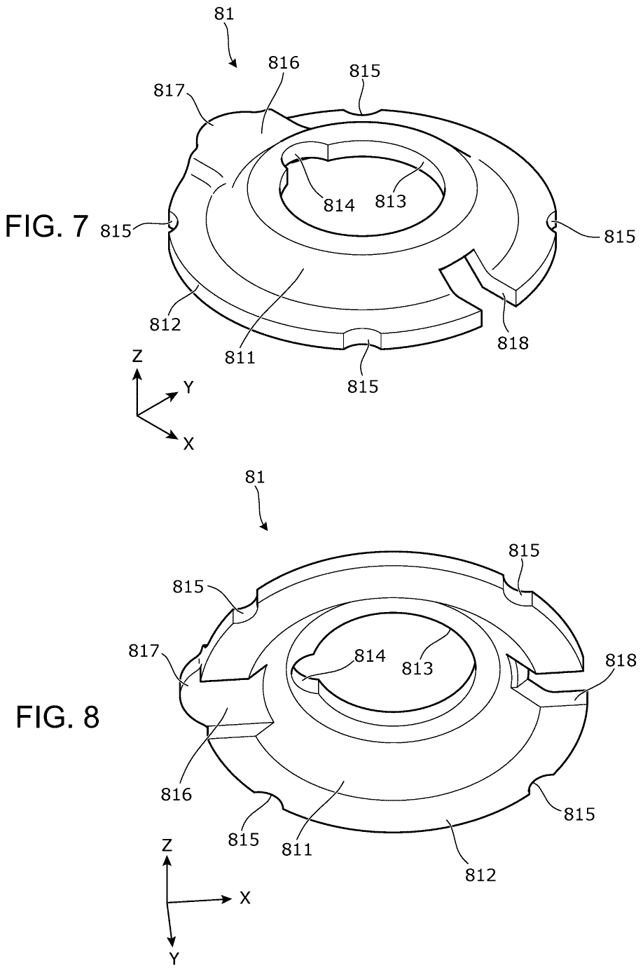

FIG. 7 is a perspective view of first cap 81 according to the exemplary embodiment viewed from above. FIG. 8 is a perspective view of first cap 81 according to the exemplary embodiment viewed from below. As illustrated in FIG. 6 to FIG. 8, first cap 81 is a ring formed from sheet metal, but may be formed from other materials, for example, resin. First cap 81 includes: first truncated cone portion 811; and first flange portion 812 projecting outward from a peripheral edge portion of first truncated cone portion 811.

First pass-through portion 813 is formed in an area of the upper surface of first truncated cone portion 811 that is located at the center as viewed in the Z-axis direction. First pass-through portion 813 includes a through-hole through which shaft 314 extends. On the inner peripheral surface of first pass-through portion 813, first vent 814 is provided at the end in the negative X-axis direction (refer to FIG. 6). First vent 814 is a cutout in the shape of a semicircle as viewed in the Z-axis direction. The present exemplary embodiment exemplifies only one first vent 814, but two or more first vents 814 may be provided.

A plurality of first recesses 815 are formed on first flange portion 812 in the circumferential direction. The present exemplary embodiment exemplifies the plurality of first recesses 815 arranged at equal intervals in the circumferential direction, but the plurality of first recesses 815 are not required to be arranged at equal intervals in the circumferential direction. Each of first recesses 815 is an arc-shaped cutout formed on the outer peripheral edge of first flange portion 812. The present exemplary embodiment exemplifies four first recesses 815, but the number of first recesses to be provided is not limited; for example, there may be one first recess.

On first flange portion 812, projecting strip 816 projecting upward and extending in the X-axis direction is formed at the end in the negative X-axis direction. The space below projecting strip 816 extends all the way in the X-axis direction and serves as a flow path for lubricant 90. An end of projecting strip 816 in the negative X-axis direction is lid portion 817 that is disposed within first housing groove 64 to close first housing groove 64. Lid portion 817 projects in the shape of an arc in the negative X-axis direction to follow first housing groove 64.

On first flange portion 812, slit 818 extending in the X-axis direction is formed at an end in the positive X-axis direction. The end of slit 818 in the positive X-axis direction is open, and the end of slit 818 in the negative X-axis direction is located in first truncated cone portion 811.

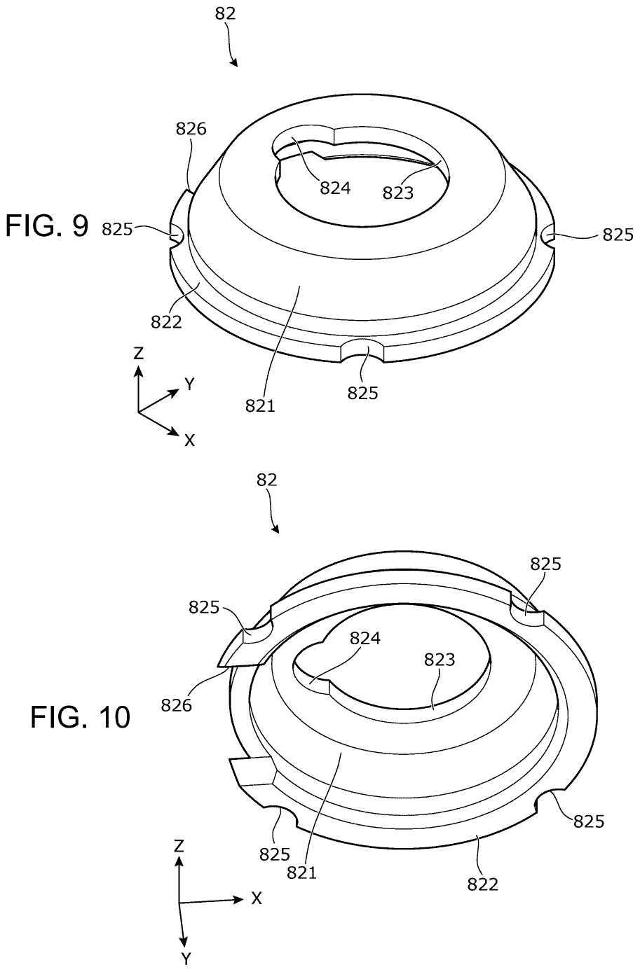

FIG. 9 is a perspective view of second cap 82 according to the exemplary embodiment viewed from above. FIG. 10 is a perspective view of second cap 82 according to the exemplary embodiment viewed from below. As illustrated in FIG. 6, FIG. 9, and FIG. 10, second cap 82 is a ring formed from sheet metal. Second cap 82 includes: second truncated cone portion 821; and second flange portion 822 projecting outward from a peripheral edge portion of second truncated cone portion 821.

Second pass-through portion 823 is formed in an area of the upper surface of second truncated cone portion 821 that is located at the center as viewed in the Z-axis direction. Second pass-through portion 823 includes a through-hole through which shaft 314 extends. On the inner peripheral surface of second pass-through portion 823, second vent 824 is provided at the end in the negative X-axis direction to overlap first vent 814. Second vent 824 is a cutout in the shape of a semicircle as viewed in the Z-axis direction. The present exemplary embodiment exemplifies only one second vent 824, but two or more second vents 824 may be provided. The overall contour of second pass-through portion 823 and second vent 824 is set to be slightly larger than the overall contour of first pass-through portion 813 and first vent 814 (refer to FIG. 6).

A plurality of second recesses 825 are formed on second flange portion 822 in the circumferential direction. The plurality of second recesses 825 are arranged at equal intervals in the circumferential direction. Each of second recesses 825 is an arc-shaped cutout formed on the outer peripheral edge of second flange portion 822. The present exemplary embodiment exemplifies four second recesses 825, but the number of second recesses to be provided is not limited; for example, there may be one second recess. Second recesses 825 are disposed at positions corresponding to first recesses 815. The area of each of second recesses 825 is preferably greater than or equal to the area of a corresponding one of first recesses 815 as viewed from above.

In other words, as viewed from above, the depth of second recess 825 measured from the outer peripheral edge of second cap 82 is preferably greater than or equal to the depth of first recess 815 measured from the outer peripheral edge of first cap 81 (refer to FIG. 6).

Furthermore, on second flange portion 822, fitting portion 826 in the form of a cutout elongated in the Y-axis direction is formed at an end in the negative X-axis direction. Projecting strip 816 of first cap 81 fits on fitting portion 826.

FIG. 11 is a cross-sectional view of bearing portion 50 according to the exemplary embodiment. FIG. 11 illustrates a cross-section extending along the axis of shaft 314. In FIG. 11, a portion of shaft 314, sleeve 70, and cap portion 80 are housed in housing 60. Shaft 314 is indicated by a dashed-double-dotted line in FIG. 11. As illustrated in FIG. 11, receiving plate 632, sleeve 70, and cap portion 80 are housed in recess 63 of housing 60, sequentially from the bottom. Specifically, receiving plate 632 in the shape of a disc is disposed in depression 631 of the bottom surface of recess 63. Receiving plate 632 receives a lower end portion of shaft 314 extending through sleeve 70 and cap portion 80. The lower end portion of shaft 314 is located below the lower surface of sleeve 70 and is in contact with receiving plate 632. The lower end portion of shaft 314 is formed in the shape of a sphere, and therefore the lower end portion and receiving plate 632 are in contact in the form similar to a point contact. Accordingly, shaft 314 can rotate smoothly.

Sleeve 70, which is disposed above receiving plate 632, is fixed in recess 63 with the caulked portions mentioned above. In cap portion 80, an upper end portion of second cap 82 projects from recess 63, but the other portions are housed in recess 63. Specifically, first cap 81 and second cap 82 are fixed by being pressed into recess 63 of housing 60. Lid portion 817 of projecting strip 816 of first cap 81 is disposed in first housing groove 64 to close said first housing groove 64. Note that an upper end portion of first cap 81 may also project from recess 63.

Next, first distance H1 between first cap 81 and second cap 82 and second distance H2 between sleeve 70 and first cap 81 will be described. First distance H1 is the distance between first cap 81 and second cap 82 in the Z-axis direction. More specifically, first distance H1 is the distance between the upper outer surface of first truncated cone portion 811 of first cap 81 and the upper inner surface of second truncated cone portion 821 of second cap 82. Second distance H2 is the distance between sleeve 70 and first cap 81 in the Z-axis direction. More specifically, second distance H2 is the distance between the leading end surface of projecting portion 73 of sleeve 70 and the upper inner surface of first truncated cone portion 811 of first cap 81. First distance H1 is greater than second distance H2 and therefore, even if lubricant 90 leaks out to the area defined by first distance H1, lubricant 90 can be stored in the area defined by first distance H1. Note that lubricant 90 is preferably stored up to a mid-level fill capacity of the space between first cap 81 and second cap 82 at all times.

Furthermore, first spacing S1 is formed between the inner peripheral surface (inner side surface) of sleeve 70 and the outer peripheral surface (outer side surface) of shaft 314. Second spacing S2 is formed between the outer peripheral surface (outer side surface) of sleeve 70 and first housing groove 64. Second spacing S2 has a generally consistent cross-sectional profile and extends in the Z-axis direction. Third spacing S3, which is connected to first spacing S1 and second spacing S2, is formed between the upper surface of sleeve 70 and the lower surface of projecting strip 816 of first cap 81. Fourth spacing S4, which is connected to first spacing S1 and second spacing S2, is formed between the lower surface of sleeve 70 and second housing groove 65 of housing 60.

Lubricant 90 is contained in recess 63 of housing 60. In FIG. 11, lubricant 90 is shown with dot shading. Lubricant 90 is also contained in first spacing S1, second spacing S2, third spacing S3, and fourth spacing S4.

### [Operation]

Next, the operation of blower 10 will be described. When an electric current is supplied to coils 42 of blower 10, magnetic flux is generated at corresponding teeth 411. With the effect of the magnetic flux generated between teeth 411 and magnet 33, torque acting in the circumferential direction is generated between stator portion 40 and rotor portion 30. As a result, propeller 31 rotates around shaft 314, and blades 312 create an air flow. Rotating shaft 314 is stably supported on bearing portion 50.

When shaft 314 rotates, lubricant 90 in recess 63 of housing 60 forms a circulating flow through first spacing S1, fourth spacing S4, second spacing S2, and third spacing S3. Specifically, with the rotation of shaft 314, propulsion attributable to guide grooves 72 of sleeve 70 acts on lubricant 90 in first spacing S1. Accordingly, a downward flow of lubricant 90 is produced in first spacing S1. Lubricant 90 that has flowed downward in first spacing S1 moves into fourth spacing S4. Lubricant 90 flows in fourth spacing S4 outward in the radial direction of recess 63, and moves into second spacing S2. Lubricant 90 flows upward in second spacing S2, and moves into third spacing S3. When this flow is repeated, lubricant 90 circulates through first spacing S1, fourth spacing S4, second spacing S2, and third spacing S3. This means that first spacing S1, fourth spacing S4, second spacing S2, and third spacing S3 form a circulation path for lubricant 90.

In this manner, lubricant 90 circulates in recess 63 of housing 60, and therefore air bubbles B contained in lubricant 90 can be kept from accumulating in each of the spacings. Furthermore, circulating air bubbles B are lighter than lubricant 90 and therefore tend to gather around shaft 314 by the centrifugal force attributed to the rotation of shaft 314. Since first vent 814 of first cap 81 is a cutout on first pass-through portion 813, air bubbles B that have gathered around shaft 314 are released to the outside of first cap 81 through first vent 814. As a result of second vent 824 of second cap 82 being disposed above first vent 814, air bubbles B released through first vent 814 can be smoothly released to the outside of second cap 82 through second vent 824. Therefore, seizing issues due to air bubbles B can be reduced. Air bubbles B contained in lubricant 90 can also be released to the outside through first recesses 815 of first cap 81 and second recesses 825 of second cap 82.

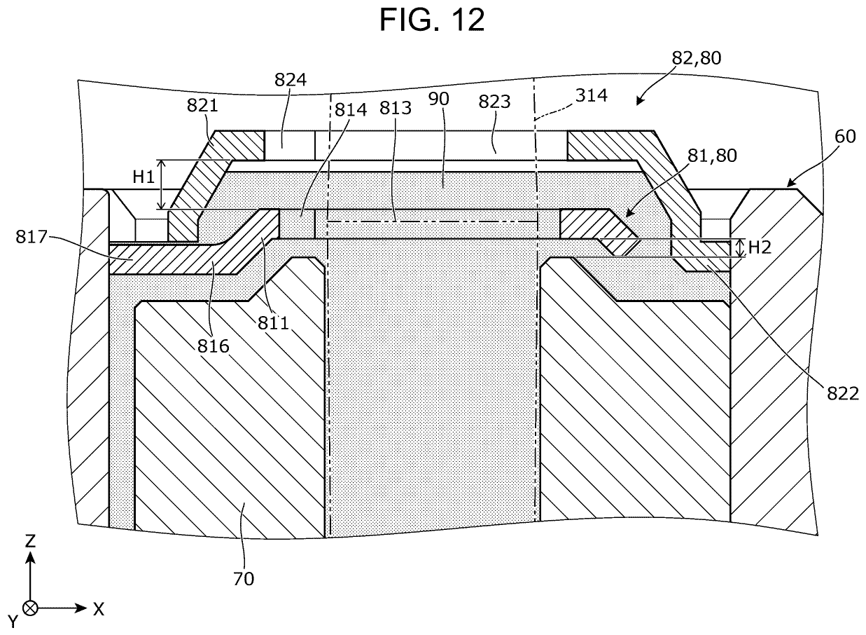

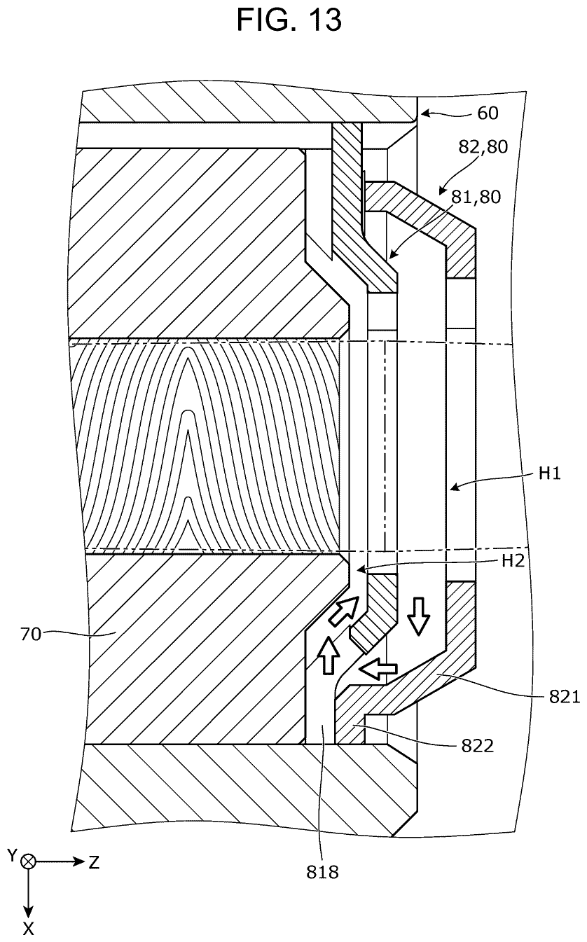

Lubricant 90 may leak out of first cap 81 depending on vibration, the posture of blower 10, and the like. FIG. 12 is an enlarged cross-sectional view of a portion of blower 10 according to the exemplary embodiment. FIG. 12 shows the state where lubricant 90 has leaked out of first cap 81. Even if lubricant 90 leaks through first pass-through portion 813, first vent 814, and first recess 815 of first cap 81, second cap 82 minimizes further leakage. At this time, since first distance H1 is greater than second distance H2, a major portion of lubricant 90 can be contained within the area defined by second distance H2, and the leakage of lubricant to the outside of second cap 82 can be more reliably minimized. Furthermore, even if lubricant 90 leaks out, said lubricant 90 can be collected through first recesses 815, slit 818, and second recesses 825 of second cap 82.

The collection of lubricant 90 through slit 818 is effective when blower 10 is disposed with a posture such that the axis thereof extends horizontally. FIG. 13 is a partial cross-sectional view of blower 10 according to the exemplary embodiment, disposed with a posture such that the axis thereof extends horizontally. As illustrated in FIG. 13, blower 10 is disposed so that slit 818 is located at a lower level. Since the rotation of shaft 314 generates pressure that causes circulation of lubricant 90 within the area defined by second distance H2, lubricant 90 is easily drawn into first cap 81 through slit 818. Specifically, lubricant 90 that has leaked out of first cap 81 is collected into first cap 81 through slit 818, as indicated by the arrows in FIG. 13.

### Advantageous Effects, Etc.

As described above, in blower 10 according to the present exemplary embodiment, since first cap 81 includes first vent 814, air bubbles B can be released to the outside through first vent 814, enabling a reduction in seizing issues due to air bubbles B. Furthermore, since cap portion 80 has a double structure of first cap 81 and second cap 82, even if lubricant 90 leaks through first pass-through portion 813 and first vent 814 of first cap 81, second cap 82 can minimize further leakage. In particular, lubricant 90 that has leaked from first cap 81 can be returned to the inside of first cap 81 through first vent 814. Thus, the leakage of lubricant 90 can be reduced.

Since air bubbles B within lubricant 90 tend to gather around shaft 314, when first vent 814 is a cutout on first pass-through portion 813, air bubbles B are directed to first vent 814, allowing for easy release of air bubbles B. Thus, seizing issues due to air bubbles B can be further reduced.

Thus, second cap 82 includes second vent 824, allowing air bubbles B released through first vent 814 to be released to the outside through second vent 824. This facilitates the smooth release of air bubbles B.

Furthermore, second vent 824 is a cutout on second pass-through portion 823, allowing air bubbles B gathering around shaft 314 to be efficiently released to the outside through second vent 824.

Furthermore, first distance H1 is greater than second distance H2, which ensures that even if lubricant 90 leaks out to the area defined by first distance H1, lubricant 90 can be contained therein. This allows for a reduction in the leakage of lubricant 90 from second cap 82. Furthermore, since second distance H2 is less than first distance H1, pressure can be readily generated to circulate lubricant 90 into the area defined by second distance H2. This also allows for the smooth circulation of lubricant 90.

Furthermore, the outer peripheral portion of first cap 81 includes first recess 815, allowing air bubbles B to be released also through first recess 815. Moreover, lubricant 90 present between first cap 81 and second cap 82 can be collected from first recess 815 into recess 63 of housing 60.

Furthermore, the outer peripheral portion of second cap 82 includes second recess 825 that overlaps first recess 815, allowing air bubbles B released through first recess 815 to be released to the outside through second recess 825.

Furthermore, the area of second recess 825 is greater than or equal to the area of first recess 815 as viewed in the up-down direction (as viewed from above), which ensures that even if lubricant 90 leaks out of second cap 82, lubricant 90 can be guided from second recess 825 to first recess 815, and the collection of lubricant 90 can be facilitated. When the area of first recess 815 viewed in the up-down direction (viewed from above) is set to induce capillary action, the effect of facilitating the collection improves.

Furthermore, the depth of second recess 825 measured from the outer peripheral edge of second cap 82 is greater than or equal to the depth of first recess 815 measured from the outer peripheral edge of first cap 81 as viewed in the up-down direction (as viewed from above), which ensures that even if lubricant 90 leaks out of second cap 82, lubricant 90 can be guided from second recess 825 to first recess 815, and the collection of lubricant 90 can be facilitated. When the depth of first recess 815 measured from the outer peripheral edge of first cap 81 is set to induce capillary action, the effect of facilitating the collection improves.

Furthermore, the outer peripheral portion of first cap 81 includes slit 818, which ensures that lubricant 90 that has leaked out to the area between first cap 81 and second cap 82 can be collected from slit 818 into recess 63 of housing 60.

### Other Variations

Blower 10 according to the present exemplary embodiment has been described thus far, but the present invention is not limited to the exemplary embodiment described above. The exemplary embodiment disclosed herein is an exemplification in all aspects, and is not intended to be limiting; all modifications made within a range that is the same as or equivalent to the Claims are intended to be included in the scope of the present invention. In the following description, portions that are substantially the same as those in the above exemplary embodiment are assigned the same reference signs as those in the above exemplary embodiment, and description thereof may be omitted.

For example, the above exemplary embodiment illustrates the case where only one route of the circulation path is provided. However, the circulation path may include more than one route. For example, in addition to the circulation path formed in the negative X-axis direction of shaft 314 described above (first spacing S1, fourth spacing S4, second spacing S2, and third spacing S3), a circulation path may be formed in the positive X-axis direction of shaft 314.

Furthermore, the above exemplary embodiment illustrates the case where first vent 814 is a cutout on first pass-through portion 813. However, the first vent may be a through-hole independent of the first pass-through portion. The same applies to the second vent.

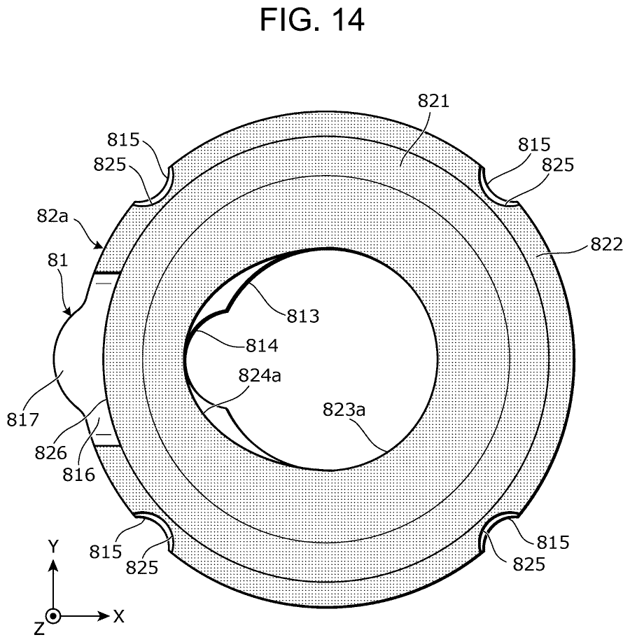

Furthermore, the shape of each of the second pass-through portion and the second vent of the second cap is not limited. FIG. 14 is a top view of second cap 82a according to Variation 1. In FIG. 14, which corresponds to FIG. 6, first cap 81 is also illustrated. As illustrated in FIG. 14, in second cap 82a, second pass-through portion 823a and second vent 824a are integrated in the shape of an egg as viewed from above. Second pass-through portion 823a overlaps first pass-through portion 813, and the portion of second pass-through portion 823a that extends beyond first pass-through portion 813 functions as second vent 824a. Note that the first pass-through portion and the first vent of the first cap may be integrated likewise in the shape of an egg as viewed from above.

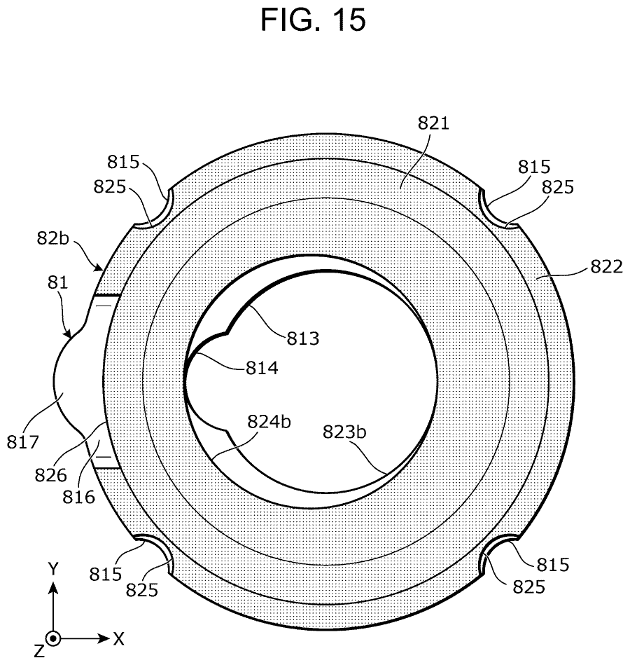

FIG. 15 is a top view of second cap 82b according to Variation 2. In FIG. 15, which corresponds to FIG. 6, first cap 81 is also illustrated. As illustrated in FIG. 15, in second cap 82b, second pass-through portion 823b and second vent 824b are integrated in the shape of a circle. Second pass-through portion 823b overlaps first pass-through portion 814, and the portion of second pass-through portion 823b that extends beyond first pass-through portion 814 functions as second vent 824b. Note that the first pass-through portion and the first vent of the first cap may be integrated likewise in the shape of a circle. When the first pass-through portion and the first vent of the first cap are integrated in the shape of a circle, the first pass-through portion and the first vent of the second cap may be integrated in the shape of a circle. In this case, a portion that overlaps the shaft and the adjacent region thereof function as a vent portion (a first vent portion or a second vent portion), and the remaining portion functions as a vent (the first vent or the second vent).

Forms obtained by arbitrarily combining structural elements included in the above exemplary embodiment and variations thereof are included within the scope of the present invention.

### INDUSTRIAL APPLICABILITY

The present disclosure is useful, for example, for blowers embedded in electronic devices.

Reference Signs List

| | |
|---|---|
| 10 | blower |
| 20 | frame |
| 21 | opening portion |
| 22 | beam portion |
| 23 | base |
| 30 | rotor portion |
| 31 | propeller |
| 32 | yoke |
| 33 | magnet |
| 40 | stator portion |
| 41 | stator core |
| 42 | coil |
| 43 | circuit board |
| 50 | bearing portion |
| 60 | housing |
| 61 | base portion |
| 62 | cylindrical portion |
| 63 | recess |
| 64 | first housing groove |
| 65 | second housing groove |
| 70 | sleeve |
| 71 | through-hole |
| 72 | guide groove |
| 73 | projecting portion |
| 80 | cap portion |
| 81 | first cap |
| 82, 82a, 82b | second cap |
| 90 | lubricant |
| 311 | body portion |
| 312 | blade |
| 313 | bottom portion |
| 314 | shaft |
| 411 | tooth |
| 632 | receiving plate |
| 811 | first truncated cone portion |
| 812 | first flange portion |
| 813 | first pass-through portion |
| 814 | first vent |
| 815 | first recess |
| 816 | projecting strip |
| 817 | lid portion |
| 818 | slit |
| 821 | second truncated cone portion |
| 822 | second flange portion |
| 823, 823a, 823b | second pass-through portion |
| 824, 824a, 824b | second vent |
| 825 | second recess |
| 826 | fitting portion |
| B | air bubbles |
| H1 | first distance |
| H2 | second distance |
| S1 | first spacing |
| S2 | second spacing |
| S3 | third spacing |
| S4 | fourth spacing |

1. A blower comprising:
a housing including a recess that is open upward;
a sleeve disposed in the recess and including a through-hole;
a shaft extending through the through-hole;
a cap portion disposed above the sleeve with the shaft extending through the through-hole;
a propeller connected to an upper end of the shaft; and
a lubricant contained in the recess, wherein
the cap portion includes a first cap and a second cap disposed above the first cap,
the first cap incudes a first vent and a first pass-through portion through which the shaft extends, and
the second cap includes a second pass-through portion through which the shaft extends.

2. The blower according to claim 1, wherein
the first vent is a cutout on the first pass-through portion.

3. The blower according to claim 1, wherein
the second cap further includes a second vent.

4. The blower according to claim 3, wherein
the second vent is a cutout on the second pass-through portion.

5. The blower according to claim 1, wherein
a first distance between the first cap and the second cap is greater than a second distance between the sleeve and the first cap.

6. The blower according to claim 1, wherein
an outer peripheral portion of the first cap includes a first recess in a form of a cutout.

7. The blower according to claim 6, wherein
an outer peripheral portion of the second cap includes a second recess in a form of a cutout that overlaps the first recess as viewed from above.

8. The blower according to claim 7, wherein
an area of the second recess is greater than or equal to an area of the first recess as viewed from above.

9. The blower according to claim 7, wherein
a depth of the second recess measured from an outer peripheral edge of the second cap is greater than or equal to a depth of the first recess measured from an outer peripheral edge of the first cap as viewed from above.

10. The blower according to claim 1, wherein
an outer peripheral portion of the first cap includes a slit extending toward a center of the first cap.
